(19) United States
(12) Patent Application Publication
(10) Pub. No.: US 2009/0322665 A1
(43) Pub. Date: Dec. 31, 2009

(54) LIQUID CRYSTAL DISPLAY ELEMENT, METHOD OF DRIVING THE ELEMENT, AND ELECTRONIC PAPER UTILIZING THE ELEMENT

(75) Inventor: Toshiaki Yoshihara, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/553,641

(22) Filed: Sep. 3, 2009

Related U.S. Application Data
(63) Continuation of application No. PCT/JP2007/054525, filed on Mar. 8, 2007.

(51) Int. Cl. G09G 3/36; G02F 1/133

(52) U.S. Cl. 345/94; 349/33

(57) ABSTRACT

A method of driving a liquid crystal display element includes: applying a scan signal voltage to N scan electrodes simultaneously selected from among a plurality of scan electrodes formed in parallel on an inner surface of one of a pair of substrates between which a cholesteric liquid crystal selectively reflecting light having a predetermined wavelength is enclosed for a selection time T and applying a reset voltage for resetting the liquid crystal to a plurality of data electrodes formed on an inner surface of the other of the pair of substrates so as to intersect the plurality of scan electrodes when viewed in the normal direction of a substrate surface. The reset voltage is applied in synchronism with the application of the scan signal voltage. The step is repeated while shifting the N simultaneously selected scan electrodes sequentially to perform a display reset for putting the liquid crystal in a homeotropic state by applying the reset voltage to each pixel on each of the scan electrodes N times consecutively. The display reset is performed using such a selection time T and a simultaneously selected electrode count N that the product T×N satisfies T×N>τ where τ represents a response time required for the liquid crystal to change from a planar state to the homeotropic state.

This application is a continuation of International Application No. PCT/JP2007/054525, filed Mar. 8, 2007.

### 1. FIELD

The present invention relates to a liquid crystal display element in which a liquid crystal material, particularly, a liquid crystal composition exhibiting a cholesteric phase is driven to display an image, a method of driving the element, and electronic paper utilizing the element.

### 2. BACKGROUND

Recently, various enterprises and universities are actively engaged in the development of electronic paper. The most promising application of electronic paper is electronic books, and other applications include the field of portable apparatus such as sub-displays of mobile terminal apparatus, and display sections of IC cards. One type of display elements used for electronic paper is liquid crystal display elements utilizing a liquid crystal composition forming a cholesteric phase (such a composition is referred to as “cholesteric liquid crystal” or “chiral nematic liquid crystal”, and the term “cholesteric liquid crystal” will hereinafter be used). A cholesteric liquid crystal has excellent features such as semi-permanent display retention characteristics (capability of displaying an image when no electric power is supplied; memory characteristics), vivid color display characteristics, high contrast characteristics, and high resolution characteristics.

In a liquid crystal display element displaying an image by taking advantage of selective reflection at a cholesteric liquid crystal, in order to reset a state of display, the liquid crystal must temporarily be put in a homeotropic state at all pixels by applying a high voltage to the cholesteric liquid crystal. Such a reset process is problematic in that great electric power is consumed to put the liquid crystal at all pixels in the homeotropic state temporarily. The consumption of great electric power for resetting can be a big problem in portable apparatus which are limited in instantaneous electric power.

### SUMMARY

A method of driving a liquid crystal display element comprising: applying a scan signal voltage to N scan electrodes simultaneously selected from among a plurality of scan electrodes formed in parallel on an inner surface of one of a pair of substrates between which a cholesteric liquid crystal selectively reflecting light having a predetermined wavelength is enclosed for a selection time T and applying a reset voltage for resetting the liquid crystal to a plurality of data electrodes formed on an inner surface of the other of the pair of substrates so as to intersect the plurality of scan electrodes when viewed in the normal direction of a substrate surface, the reset voltage being applied in synchronism with the application of the scan signal voltage, wherein the applying step is repeated while shifting the N simultaneously selected scan electrodes sequentially to perform a display reset for putting the liquid crystal in a homeotropic state by applying the reset voltage to each pixel on each of the scan electrodes N times consecutively, and the display reset is performed using such a selection time T and a simultaneously selected electrode count N that the product T×N satisfies T×N>τ(PL→HT) where τ(PL→HT) represents a response time required for the liquid crystal to change from a planar state to the homeotropic state.

### BRIEF DESCRIPTION OF THE DRAWINGS

FIG. 1 is an illustration schematically depicting a general configuration of a multi-layer liquid crystal display element capable of color display utilizing cholesteric liquid crystals;

FIGS. 2A and 2B are illustrations for describing operations of the multi-layer liquid crystal display element capable of color display utilizing cholesteric liquid crystals;

FIG. 3 is an illustration of a schematic configuration of a liquid crystal display element according to an embodiment;

FIG. 4 is an illustration schematically depicting a sectional configuration of the liquid crystal display element according to the embodiment;

FIG. 5 is a graph depicting an example of reflection spectra observed on the liquid crystal display element according to the embodiment in the planar state;

FIGS. 6A and 6B are diagrams depicting a method of driving the liquid crystal display element according to the embodiment;

FIG. 7 is a graph depicting an example of voltage-reflectance characteristics of a cholesteric liquid crystal;

FIGS. 8A, 8B, and 8C are illustrations depicting the concept of a display reset process according to the embodiment;

FIG. 9 is a diagram depicting an example of a display reset driving waveform of the liquid crystal display element according to the embodiment;

FIGS. 10A and 10B are graphs depicting temperature dependence exhibited by the cholesteric liquid crystals of the liquid crystal display element according to the embodiment in responding to the application a voltage; and

FIGS. 11A, 11B, and 11C are illustrations of specific examples of electronic paper having the liquid crystal display element according to the embodiment.

### DESCRIPTION OF EMBODIMENTS

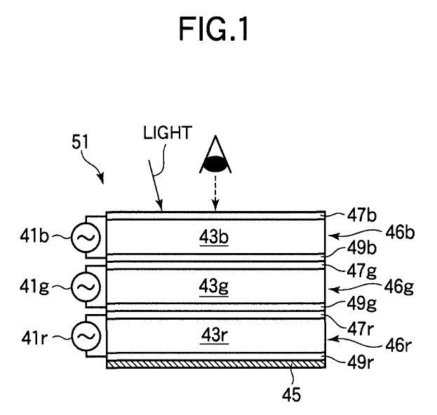

Before describing a liquid crystal display element, a method of driving the element, and electronic paper utilizing the element according to an embodiment of the invention, a description will be made with reference to FIG. 1 on a schematic configuration and an operating principle of a liquid crystal display element capable of color display utilizing cholesteric liquid crystals. FIG. 1 schematically depicts a sectional configuration of a liquid crystal display element 51. The liquid crystal display element 51 has a structure in which a blue (B) display portion 46b, a green (G) display portion 46g, and a red (R) display portion 46r are formed listed one over another in the order listed from a display surface side of the display. In the illustration, the display surface is located on the side of where a top substrate 47b is provided, and external light (represented by an arrow) impinges on the display surface from above the substrate 47b. An eye of a viewer and the viewing direction of the viewer are schematically illustrated above the substrate 47b.

The B display portion 46b includes a blue (B) liquid crystal 43b enclosed between a pair of substrates, i.e., a top substrate 47b and a bottom substrate 49b and a pulse voltage source 41b for applying a predetermined pulse voltage to the B liquid crystal 43b. The G display portion 46g includes a green (G) liquid crystal 43g enclosed between a pair of substrates, i.e., a top substrate 47g and a bottom substrate 49g and a pulse voltage source 41g for applying a predetermined pulse voltage to the G liquid crystal 43g. The R display portion 46r includes a red (R) liquid crystal 43r enclosed between a pair of substrates, i.e., a top substrate 47r and a bottom substrate 49r and a pulse voltage source 41r for applying a predetermined pulse voltage to the R liquid crystal 43r. Although not depicted, electrodes for applying the pulse voltages from the respective pulse voltage sources 41 are formed on interface sides of the top substrates 47 and the bottom substrates 49 where the substrates contact the respective liquid crystals 43. An alignment film or an insulation film may be formed in addition to electrodes on each of the interface sides of the top substrates 47 and the bottom substrates 49 where the substrates contact the liquid crystals 43 as occasion demands. A light absorbing layer 45 is disposed on a bottom surface of the bottom substrate 49r of the R display portion 46r.

A cholesteric liquid crystal used in each of the B, G, and R liquid crystals 43b, 43g, and 43r is a liquid crystal mixture obtaining by adding a relatively great amount of chiral additive (also referred to as “chiral material”) to a nematic liquid crystal to a content of several tens percent by weight. When a nematic liquid crystal includes a relatively great amount of chiral material, a cholesteric phase, which is a great helical twist of nematic liquid crystal molecules, can be formed in the liquid crystal. For this reason, a cholesteric liquid crystal is also referred to as “chiral nematic liquid crystal”.

A cholesteric liquid crystal has bi-stability (memory characteristics), and the liquid crystal can be put in any of a planar state, a focal conic state, or an intermediate state which is a mixture of the planar state and the focal conic state by adjusting the intensity of an electric field applied to the same. Once the liquid crystal enters the planar state, the focal conic state, or the mixed or intermediate state, the state is thereafter kept with stability even after the electric field is removed.

The planar state can be obtained by applying a predetermined high voltage between a top substrate 47 and a bottom substrate 49 to apply a strong electric field to the liquid crystal 43 and to thereby reset the liquid crystal 43 to the homeotropic state and thereafter nullifying the electric field abruptly. For example, the focal conic state can be obtained by applying a predetermined voltage lower than the above-described high voltage between the top substrate 47 and the bottom substrate 49 to apply an electric field to the liquid crystal 43 and thereafter nullifying the electric field abruptly. The focal conic state may alternatively be obtained by gradually applying a voltage to a liquid crystal in the planar state.

For example, the intermediate state which is a mixture of the planar state and the focal conic state can be obtained by applying a voltage lower than the voltage to obtain the focal conic state between the top substrate 47 and the bottom substrate 49 to apply an electric field to the liquid crystal 43 and thereafter nullifying the electric field abruptly.

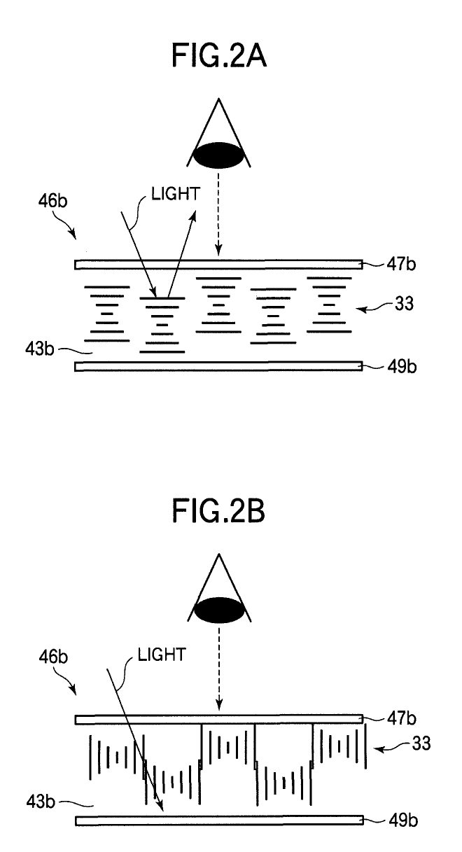

A display principle of the liquid crystal display element 51 utilizing cholesteric liquid crystals will now be described by referring to the B display portion 46b as an example. FIG. 2A depicts alignment of liquid crystal molecules 33 in the B liquid crystal 43b of the B display portion 46b observed when the layer is in the planar state. As depicted in FIG. 2A, in the planar state, the liquid crystal molecules 33 are sequentially rotated in the thickness direction of the substrates to form helical structures, and helical axes of the helical structures are substantially perpendicular to substrate surfaces.

In the planar state, light in a predetermined wave band in accordance with the helical pitch of the liquid crystal molecules 33 is selectively reflected by the liquid crystal. The reflected light is circularly polarized light which is either left- or right handed depending on the chirality of the helical structures, and other types of light are transmitted by the liquid crystal. Natural light is a mixture of left- and right-handed circularly polarized light. Therefore, when natural light in the predetermined wave band impinges on the liquid crystal in the planar state, it may be assumed that 50% of the incident light is reflected with the other 50% transmitted.

A wavelength λ at which maximum reflection takes place is given by λ=n·p where n represents the average refractive index of the liquid crystal and p represents the helical pitch.

Therefore, in order to allow blue light to be selectively reflected by the B liquid crystal 43b of the B display portion 46b in the planar state, the average refractive index n and the helical pitch p are determined, for example, such that an equation “λ=480 nm” holds true. The average refractive index n can be adjusted by selecting the liquid crystal material and the chiral material appropriately, and the helical pitch p can be adjusted by adjusting the chiral material content.

FIG. 2B depicts alignment of the liquid crystal molecules 33 observed when the B liquid crystal 43b of the B display portion 46b is in the focal conic state. As depicted in FIG. 2B, in the focal conic state, the liquid crystal molecules 33 are sequentially rotated in an in-plane direction of the substrates to form helical structures, and helical axes of the helical structures are substantially parallel to the substrate surfaces. In the focal conic state, the B liquid crystal 43b loses the selectivity of wavelengths to be reflected, and most of incident light is transmitted by the layer. Since the transmitted light is absorbed by the light absorbing layer 45 disposed on the bottom surface of the bottom substrate 49r in the R display portion, a dark state (black) can be displayed.

In the intermediate state that is a mixture of the planar state and the focal conic state, the ratio between reflected light and transmitted light is adjusted according to the ratio of presence between the planar and focal conic states, and the intensity of reflected light varies accordingly. Therefore, multi-gray-level display can be performed according to intensities of reflected light.

As thus described, the quantity of light reflected by the cholesteric liquid crystal can be controlled by a helically twisted state of alignment of liquid crystal molecules 33. Cholesteric liquid crystals selectively reflecting green and red light rays in the planar state are used in the G liquid crystal 43g and the R liquid crystal 43r, respectively, just as done in the B liquid crystal 43b, and the B display portion 46b, the G display portion 46g, and the R display portion 46r are formed one over another to fabricate a liquid crystal display element 51 capable of full-color display. The liquid crystal display element 51 has memory characteristics, and it is capable of performing color display without consuming electric power except during a screen rewrite.

The liquid crystal display element 51 displaying an image utilizing selective reflection at cholesteric liquid crystals as thus described must involve a display reset process in which a high voltage is applied to temporarily put the cholesteric liquid crystals in the homeotropic state regardless of the state of the cholesteric liquid crystals, i.e., the planar state, the focal conic state, or the mixed or intermediate state.

The illustration of the liquid crystal display element 51 focuses on one pixel or segment of the display to describe a principle of a display operation utilizing cholesteric liquid crystals, and no consideration is needed for the problem of electric power consumed by the display reset process for the illustrated instance. However, when a liquid crystal display element having a plurality of pixels arranged in the form of a matrix or a liquid crystal display element having a plurality of segments is incorporated in a portable apparatus, an increase in power consumption attributable to the display reset process constitutes a problem which cannot be ignored.

For example, in a passive matrix liquid crystal display element, a plurality of pixels are provided by forming a plurality of scan electrodes and data electrodes in vertical and horizontal directions in the form of a matrix. In general, instantaneous electric power available in a portable apparatus for driving such a liquid crystal display element is somewhat limited, and it is therefore difficult to accommodate excessively great power consumption required to put the liquid crystal at all pixels in the homeotropic state at a time when the display reset process is performed.

In order to solve such a problem, a method has been proposed, which includes the step of selecting some of scan electrodes simultaneously and applying a reset voltage to the electrodes in a synchronized manner. The step is repeated with the simultaneously selected scan electrodes sequentially shifted one place each time the step is performed. Thus, the reset voltage is consecutively applied plural times to each pixel on each scan electrode to put the liquid crystal in the homeotropic state (International Publication No. WO2006/103738).

Since the reset process is performed only for the liquid crystal on some of scan electrodes which have been simultaneously selected, instantaneous electric power required for a reset can be kept small, and the reset process can therefore be performed in a portable apparatus which has limited instantaneous electric power. However, the proposed display resetting method neither discloses nor suggests the optimal number of scan electrodes to be simultaneously selected. In order to suppress instantaneous electric power required for a reset, the number of simultaneously selected scan electrodes must be as small as possible. Further, the relationship between a reset process and a subsequent data rewrite must be clarified to allow a display reset process to be performed with stability.

The present embodiment of the invention employs a driving method as described below for when a display reset process is performed.

A selection time T required per scan electrode and a simultaneously selected electrode count N, i.e., the number of scan electrodes to be simultaneously selected, are defined in advance such that the product (T×N) of the selection time T and the simultaneously selected electrode count N satisfies T×N>τ(PL→HT) where τ(PL→HT) represents a response time required for a cholesteric liquid crystal to change from the planar state to the homeotropic state.

Next, a scan signal voltage is applied for the selection time T to N scan electrodes which have been simultaneously selected from among a plurality of scan electrodes formed in parallel on an inner surface of one of a pair of substrates enclosing a cholesteric liquid crystal selectively reflecting light rays having predetermined wavelengths (step S1).

A reset voltage for resetting the liquid crystal is applied in synchronism with the application of the scan signal voltage to a plurality of data electrodes formed in parallel on an inner surface of the other substrate so as to extend across the plurality of scan electrodes when viewed in the normal direction of substrate surfaces (step S2).

The steps S1 and S2 are repeated with the N simultaneously selected scan electrodes sequentially shifted one place each time the steps are performed to apply the reset voltage N times consecutively to each pixel on each scan electrode.

The inventor conducted a close study in search of a step which allows predetermined pixels to be reset to a reflective state after a voltage is applied to a plurality of simultaneously selected scan electrodes. As a result, it was found that predetermined pixels can be uniformly put in a reflective state when T×N>τ(PL→HT) is true as described above.

Thus, a cholesteric liquid crystal can be reliably put in the homeotropic state, and the number of simultaneously selected scan electrodes can be made small as occasion demands. It is therefore possible to minimize instantaneous electric power at the time of a reset, and a display reset can be carried out even on a portable apparatus which is limited in instantaneous electric power.

When data is written at a pixel on a predetermined scan electrode after a display reset, time t spent before the data write is started after the display reset is set to satisfy t>τ(HT→PL) where τ(HT→PL) represents a response time required for the liquid crystal to change from the homeotropic state to the planar state.

The inventor found that such a setting allows a stable state of reflection to be achieved at a predetermined pixel after the application of a reset signal based on simultaneous selection. Thus, a uniform state of display can be achieved.

Response of a cholesteric liquid crystal to the application of a voltage has temperature dependence. Therefore, the response time τ(PL→HT) and the response time τ(HT→PL) also depend on the temperature of the liquid crystal. For this reason, the product T×N and the time t in the present embodiment are determined based on the temperature of the liquid crystal at the time of a display reset. Since the product T×N and the time t can therefore be optimally selected according to the temperature of the liquid crystal, the reset process and display of an image can be stably performed without being affected by fluctuations of ambient temperature.

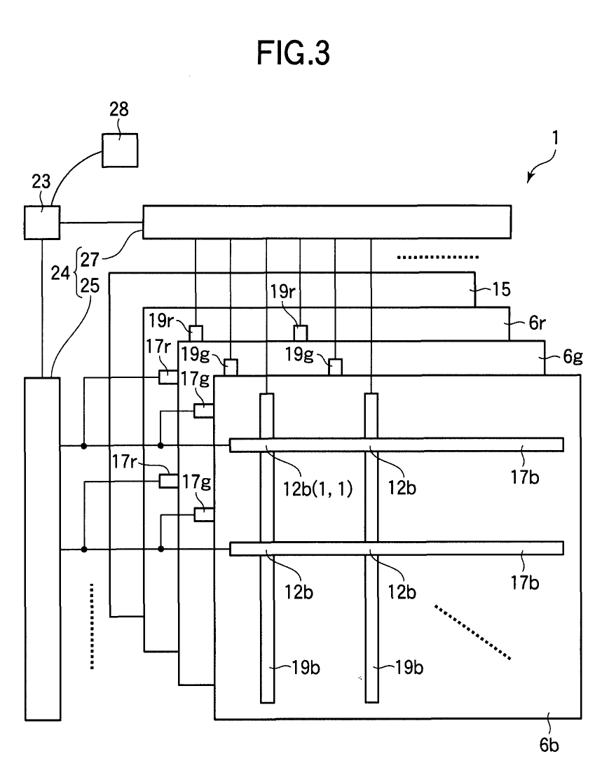

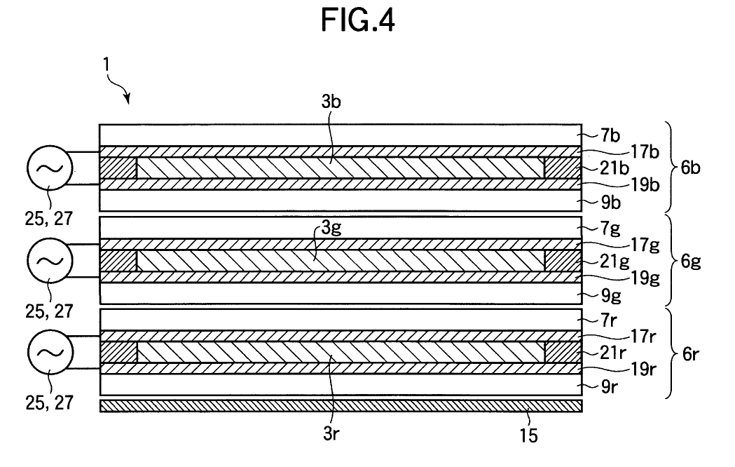

A liquid crystal display element, a method of driving the element, and electronic paper utilizing the element according to the present embodiment will now be described with reference of FIGS. 3 to 11C. A liquid crystal display element 1 utilizing cholesteric liquid crystals for blue (B), green (G), and red (R) will now be described as an exemplary element according to the embodiment. FIG. 3 depicts a schematic configuration of the liquid crystal display element 1 of the present embodiment. FIG. 4 schematically depicts a sectional configuration of the liquid crystal display element 1 taken along an imaginary straight line extending in the horizontal direction of FIG. 3.

As depicted in FIGS. 3 and 4, the liquid crystal display element 1 includes B display portion 6b selectively reflecting blue (B) light as a selected waveband in the planar state, a G display portion 6g selectively reflecting green (G) light as a selected waveband in the planar state, and an R display portion 6r selectively reflecting red (R) light as a selected waveband in the planar state. The B, G, and R display portions 6b, 6g, and 6r are formed one over another in the order listed from the side of the element where a light entrance surface (display surface) is provided.

The B display portion 6b has a pair of substrates, i.e., a top substrate 7b and a bottom substrate 9b disposed opposite to each other and a B liquid crystal 3b enclosed between the substrates 7b and 9b. The B liquid crystal 3b is a cholesteric liquid crystal which has an average refractive index n and a helical pitch p adjusted to reflect blue light selectively and has rightward optical rotatory power (rightward chirality). The liquid crystal reflects blue right-handed circularly polarized light and transmits other types of light in the planar state and which transmits substantially all types of light in the focal conic state.

The G display portion 6g has a pair of substrates, i.e., a top substrate 7g and a bottom substrate 9g disposed opposite to each other and a G liquid crystal 3g enclosed between the substrates 7g and 9g. The G liquid crystal 3g is a cholesteric liquid crystal which has an average refractive index n and a helical pitch p adjusted to reflect green light selectively and has leftward optical rotatory power (leftward chirality). The liquid crystal reflects green left-handed circularly polarized light and transmits other types of light in the planar state and which transmits substantially all types of light in the focal conic state.

The R display portion 6r has a pair of substrates, i.e., a top substrate 7r and a bottom substrate 9r disposed opposite to each other and an R liquid crystal 3r enclosed between the substrates 7r and 9r. The R liquid crystal 3r is a cholesteric liquid crystal which has an average refractive index n and a helical pitch p adjusted to reflect red light selectively and has rightward optical rotatory power (rightward chirality). The liquid crystal reflects red right-handed circularly polarized light and transmits other types of light in the planar state and which transmits substantially all types of light in the focal conic state.

The choesteric liquid crystal used as each of the B, G, and R liquid crystals 3b, 3g, and 3r is obtained by adding a chiral material to a nematic liquid crystal mixture to a content of 10 to 40 percent by weight. The chiral material content is a value based on an assumption that the total amount of the nematic liquid crystal component and the chiral material constitutes 100 percent by weight. Various types of known nematic liquid crystals may be used. The cholesteric liquid crystals preferably have refractive index anisotropy Δn having a value satisfying 0.18≦Δn≦0.24. When the refractive index anisotropy Δn is smaller than the range, the liquid crystals 3b, 3g, and 3r have low reflectances in the planar state. When the refractive index anisotropy is greater than the range, the liquid crystals 3b, 3g, and 3r have significant scatter reflections in the focal conic state, and the layers have high viscosity which reduces the speed of response.

The chiral material added in the B and R cholestric liquid crystals and the chiral material added in the G cholesteric liquid crystal are optical isomers of each other in that they are different from each other in optical rotatory power. Therefore, the B and R cholesteric liquid crystals are the same as each other and different from the G cholesteric liquid crystal in terms of optical rotatory power.

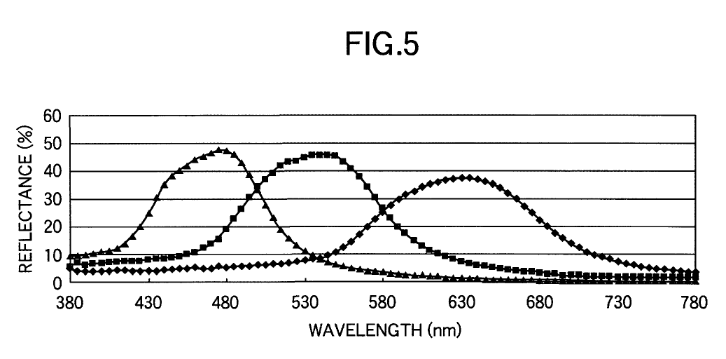

FIG. 5 depicts examples of reflection spectra observed at the liquid crystals 3b, 3g, and 3r in the planar state. Wavelengths (nm) of reflected light are depicted along the horizontal axis, and reflectances (in comparison to that of a white plate (in percents)) are depicted along the vertical axis. The reflection spectrum observed at the B liquid crystal 3b is represented by the curve connecting the triangular symbols. Similarly, the reflection spectrum observed at the G liquid crystal 3g is represented by the curve connecting the square symbols, and the reflection spectrum observed at the R liquid crystal 3r is represented by the curve connecting the rhombic symbols.

As depicted in FIG. 5, the center wavelengths of the reflection spectra of the liquid crystals 3b, 3g, and 3r have magnitudes ascending in the order in which the liquid crystals are listed. In the multi-layer structure formed by the B, G, and R display portions 6b, 6g, and 6r, the optical rotator power of the G liquid crystal 3g is different from the optical rotator power of the B liquid crystal 3b and the R liquid crystal 3r in the planar state. As a result, in the regions where overlaps exist between the blue and green reflection spectra and between the green and red reflection spectra, for example, right-handed circularly polarized light may be reflected by the B liquid crystal 3b and the R liquid crystal 3r, and left-handed circularly polarized light may be reflected by the G liquid crystal 3g. As a result, loss of reflected light can be suppressed to improve the brightness of the display screen of the liquid crystal display element 1.

The top substrates 7b, 7g, and 7r and the bottom substrates 9b, 9g, and 9r must have translucency. In the present embodiment, pairs of polycarbonate (PC) film substrates cut in longitudinal and transverse sizes of 10 cm×8 cm are used. Glass substrates or film substrates made of polyethylene terephthalate (PET) may be used instead of PC substrates. Such film substrates have sufficient flexibility. In the present embodiment, all of the top substrates 7b, 7g, and 7r and the bottom substrates 9b, 9g, and 9r have translucency, but the bottom substrate 9r of the R display portion 6r disposed at the bottom of the element may be opaque.

As depicted in FIGS. 3 and 4, a plurality of strip-like data electrodes 19b are formed in parallel on the side of the bottom substrate 9b facing the B liquid crystal 3b, the electrodes extending in the vertical direction of FIG. 3. In FIG. 4, reference numeral 19b represents the region where the plurality of data electrodes 19b are provided. A plurality of strip-like scan electrodes 17b are formed in parallel on the side of the top substrate 7b facing the B liquid crystal 3b, the electrodes extending in the horizontal direction of FIG. 3.

As depicted in FIG. 3, the plurality of scan electrodes 17b and the plurality of data electrodes 19b are disposed face-to-face so as to intersect each other when the top substrate 7b and the bottom substrate 9b are viewed in the normal direction of the surfaces on which the electrodes are formed. In the present embodiment, transparent electrodes are patterned to form 320 scan electrodes 17b and 240 data electrodes 19b in the form of stripes at a pitch of 0.24 mm to allow an image to be displayed with 320×240 dots or on a QVGA basis. Each of regions where the electrodes 17b and 19b intersect constitutes a B pixel 12b. A plurality of B pixels 12b are arranged in the form of a matrix having 320 rows and 240 columns.

In the G display portion 6g, 320 scan electrodes 17g, 240 data electrodes 19b, and G pixels 12g (not depicted) arranged in the form of a matrix having 320 rows and 240 columns are formed in substantially the same manner as in the B display portion 6b. Similarly, scan electrodes 17r, data electrodes 19r, and R pixels 12r (not depicted) are formed in the R display portion 6r. Each set of B, G, and R pixels 12b, 12g, and 12r form one pixel 12 of the liquid crystal display element 1. The pixels 12 are arranged in the form of a matrix to form a display surface.

For example, a typical material used to form the scan electrodes 17b, 17g, and 17r and the data electrodes 19b, 19g, and 19r is indium tin oxide (ITO). Transparent conductive films made of indium zinc oxide (IZO) or the like, metal electrodes made of aluminum, silicon, or the like, or transparent conductive films made of amorphous silicon or the like may alternatively be used.

A scan electrode driving circuit 25 including scan electrode driver ICs for driving the plurality of scan electrodes 17b, 17g, and 17r is connected to the top substrates 7b, 7g, and 7r. A data electrode driving circuit 27 including data electrode driver ICs for driving the plurality of data electrodes 19b, 19g, and 19r is connected to the bottom substrates 9b, 9g, and 9r. A driving section 24 is formed by the scan electrode driving circuit 25 and the data electrode driving circuit 27.

The scan electrode driving circuit 25 selects three predetermined scan electrodes 17b, 17g, and 17r based on a predetermined signal output from a control section 23 and simultaneously outputs scan signals to the three scan electrodes 17b, 17g, and 17r. Based on a predetermined signal output from the control section 23, the data electrode driving circuit 27 outputs image data for B, G, and R pixels 12b, 12g, and 12r on the selected scan electrodes 17b, 17g, and 17r to the respective data electrodes 19b, 19g, and 19r. For example, general-purpose STN driver ICs having a TCP (tape carrier package) structure are used as the driver ICs for the scan electrodes and the data electrodes.

In the present embodiment, since diving voltages for the B, G, and R liquid crystals 3b, 3g, and 3r can be substantially equal to each other, a predetermined output terminal of the scan electrode driving circuit 25 is commonly connected to predetermined input terminals of the scab electrodes 17b, 17g, and 17r. Thus, there is no need for providing a scan electrode driving circuit 25 for each of the B, G, and R display portions 6b, 6g, and 6r, which allows the liquid crystal display element 1 to be provided with a simple configuration. Further, since a reduction can be achieved in the number of san electrode driver ICs, the liquid crystal display element 1 can be provided at a low cost. The output terminal of the scan electrode driving circuit may be shared between the B, G, and R electrodes as occasion demands.

Obviously, each of the electrodes 17b and 19b may be coated with a functional film, e.g., an insulation film or an alignment film for controlling the alignment of liquid crystal molecules (neither of the films is depicted). The insulation film has the function of preventing shorting between the electrodes 17b and 19b, and the film also serves as a gas barrier layer having the function of improving the reliability of the liquid crystal display element 1. The alignment film may be an organic film such as a polyimide resin, a polyamide-imide resin, a polyether imide resin, a polyvinyl butyral resin, or an acryl resin, and an inorganic material such as a silicon oxide or an aluminum oxide may alternatively be used. For example, alignment films are provided throughout the substrates to coat the electrodes in the present embodiment. The alignment films may be also used as insulating thin films.

As depicted in FIG. 4, the B liquid crystal 3b is enclosed between the substrates 7b and 9b by a seal material 21b applied to the peripheries of the top substrate 7b and the bottom substrate 9b. The thickness (cell gap d) of the B liquid crystal layer 3b must be kept uniform. In order to maintain a predetermined cell gap d, spherical spacers made of a resin or inorganic oxide are dispersed in the B liquid crystal 3b. Alternatively, a plurality of columnar spacers coated with a thermoplastic resin on the surface thereof are formed in the B liquid crystal 3b. In the liquid crystal display element 1 of the present embodiment, spacers (not depicted) are inserted in the B liquid crystal 3b to keep the cell gap d uniform. More preferably, a wall structure having adhesive properties may be formed to surround pixels. Preferably, the B liquid crystal 3b has a cell gap d in the range of 3 μm≦d≦6 μm. The B liquid crystal 3b has an undesirably low reflectance when the cell gap d is smaller than the range and requires an excessively high driving voltage when the cell gap is greater than the range. In the present embodiment the cell gap d is set at 4 μm.

The structure of the G display portion 6g and the R display portion 6r will not be described because it is similar to that of the B display portion 6b. A visible light absorbing layer 15 is provided on the outer surface (bottom surface) of the bottom substrate 9r of the R display portion 6r. Since the visible light absorbing layer 15 is provided, rays of light which have not been reflected by the B, G, and R liquid crystals 3b, 3g, and 3r can be efficiently absorbed. Therefore, the liquid crystal display element 1 can display an image with a high contrast ratio. The visible light absorbing layer 15 may be provided as occasion demands.

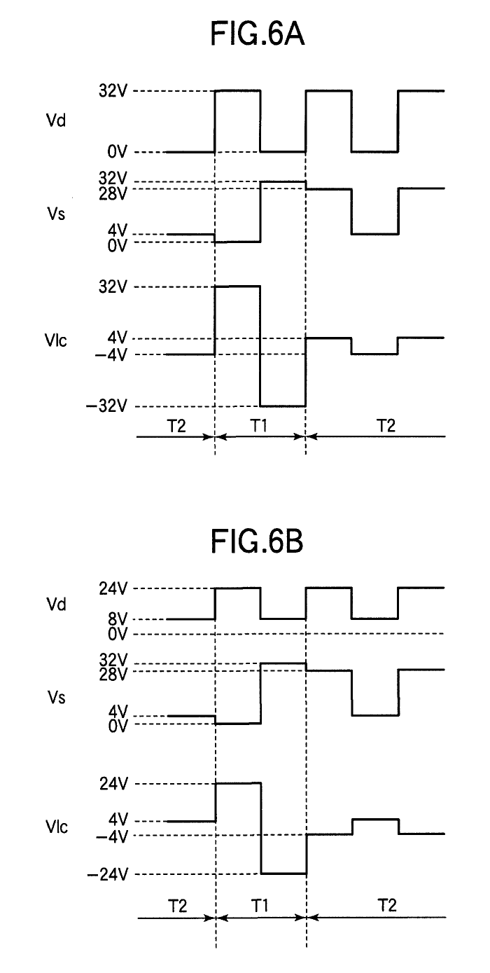

A method of driving the liquid crystal display element 1 will now be described with reference to FIGS. 6A and 6B. FIG. 6A depicts driving waveforms for putting a cholesteric liquid crystal in the planar state, and FIG. 6B depicts driving waveforms for putting a cholesteric liquid crystal in the focal conic state. In each of FIGS. 6A and 6B, a data signal voltage waveform Vd output from the data electrode driving circuit 27 is depicted in the top part; a scan signal voltage waveform Vs output from the scan electrode driving circuit 25 is depicted in the middle part; and an applied voltage waveform Vlc applied to a pixel 12b of the B liquid crystal 3b is depicted in the bottom part. In FIGS. 6A and 6B, time is depicted to lapse in the left-to-right direction in the figures, and voltages are represented in the vertical direction of the figures.

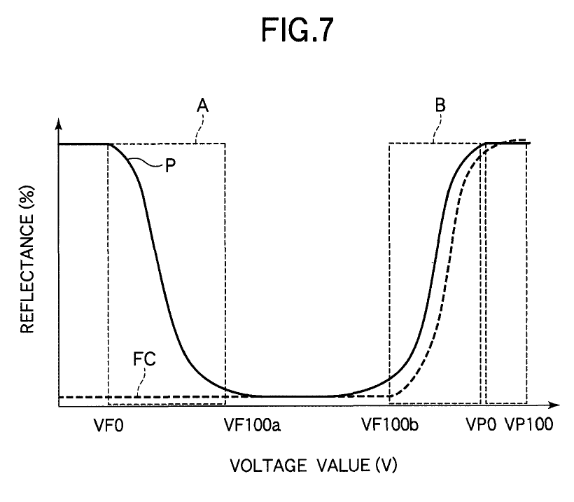

FIG. 7 depicts an example of voltage-reflectance characteristics of a cholesteric liquid crystal. Voltage values (V) applied to the cholesteric liquid crystal is depicted along the horizontal axis, and reflectances (%) of the cholesteric liquid crystal are depicted along the vertical axis. The curve P in a solid line depicted in FIG. 7 represents voltage-reflectance characteristics observed when the cholesteric liquid crystal is initially in the planar state, and the curve FC in a broken line represents voltage-reflectance characteristics observed when the cholesteric liquid crystal is initially in the focal conic state.

An example will now be described, in which a predetermined voltage is applied to a blue (B) pixel 12b (1,1) that is located at the intersection between the data electrode 19b of the first column of the B display portion 6b depicted in FIG. 3 and the scanning electrode 17b of the first row. As depicted in FIG. 6A, in the first half of a selection period T1 during which the scan electrode 17b in the first row is selected, the data signal voltage Vd is +32 V, whereas the scan signal voltage Vs is 0 V. In the second half of the period, the data signal voltage Vd is 0 V, whereas the scan signal voltage Vs is +32 V. Therefore, a pulse voltage of +32 V is applied to the B liquid crystal 3b at the B pixel 12b (1,1) during the selection period T1. When a predetermined high voltage VP100 (e.g., 32 V) is applied to the cholesteric liquid crystal as depicted in FIG. 7 to generate a strong electric field therein, the helical structure of liquid crystal molecules is completely decomposed into a homeotropic state in which all liquid crystal molecules follow the direction of the electric field.

When the selection period T1 ends and a non-selection period T2 starts, voltages of, for sample, +28 V and +4 V having a period equivalent to one half of the selection period T1 are applied to the scan electrode 17b of the first row. On the other hand, predetermined data signal voltages Vd are applied to the data electrode 19b of the first column. In FIG. 6A, voltages of, for sample, +32 V and 0 V having a period equivalent to one half of the selection period T1 are applied to the data electrode 19b of the first column in the non-election period T2 following the selection period T1. Therefore, a pulse voltage VF0 of ±4 V is applied to the B liquid crystal 3b at the B pixel 12b (1,1) during the non-selection period T2. As a result, the electric field generated in the B liquid crystal 3b at the B pixel 12b (1,1) during the non-selection period T2 is made substantially zero.

When the voltage applied to the liquid crystal changes from the voltage VP100 (±32 V) to the voltage VF0 (±4 V) to make the electric field substantially zero abruptly while the liquid crystal molecules are near the homeotropic state, the liquid crystal molecules enter a helical state in which the helical axes are directed substantially perpendicular to the electrodes 17b and 19b. Thus, the liquid crystal enters the planar state, in which rays of light in accordance with the helical pitch are selectively reflected. Since the B liquid crystal 3b at the B pixel 12b (1,1) thus enters the planar state to reflect light, blue is displayed at the B pixel 12b (1,1).

As depicted in FIG. 6B, in the first half of the selection period T1 and in the second half of the period, the data signal voltage Vd is 24 V and 8 V, respectively, whereas the scan signal voltage Vs is 0 V and +32 V, respectively. Then, a pulse voltage of ±24 V is applied to the B liquid crystal 3b at the B pixel 12b (1,1). When a predetermined low voltage VF100b (e.g., 24 V) is applied to the cholesteric liquid crystal as depicted in FIG. 7 to generate a weak electric field therein, the helical structure of the liquid crystal molecules is not completely decomposed. In the non-selection period T2, for example, voltages of +28 V and +4 V having a period equivalent to one half of the selection period T1 are applied to the scan electrode 17b of the first row, and predetermined data signal voltages Vd (e.g., +24 V and 8 V) having a period equivalent to one half of the selection period T1 are applied to the data electrode 19b. Thus, a pulse voltage of −4 V and +4 V is applied to the B liquid crystal 3b at the B pixel 12b (1,1) during the non-selection period T2. As a result, the electric field generated in the B liquid crystal 3b at the B pixel 12b (1,1) is made substantially zero during the non-selection period T2.

When the voltage applied to the cholesteric liquid crystal changes from the voltage VF100b (+24 V) to the voltage VF0 (+4 V) to make the electric field substantially zero abruptly in the state in which the helical structure of the liquid crystal molecules is not completely decomposed, the liquid crystal molecules enter a helical state in which the helical axes are directed substantially parallel to the electrodes 17b and 19b. That is, the liquid crystal molecules enter the focal conic state in which incident light is transmitted. Thus, the B liquid crystal 3b at the B pixel 12b(1,1) enters the focal conic state to transmit light. As depicted in FIG. 7, the cholesteric liquid crystal can be also put in the focal conic state by applying the voltage VP100 (V) to generate a strong electric field in the liquid crystal and by thereafter removing the electric field slowly.

The driving voltages and driving method described above are merely examples. When a pulse voltage of 30 to 35 V is applied between the electrodes for an effective duration of 20 to 100 ms at room temperature, the cholesteric liquid crystal of the B liquid crystal layer enters a state for selective reflection (planar state). When a pulse voltage of 15 to 22 V is applied for an effective duration of 20 to 100 ms, the cholesteric liquid crystal enters a highly transmissive state (focal conic state).

A green (G) pixel (1,1) and a red (R) pixel (1,1) are driven in substantially the same manner in which the B pixel (1,1) is driven, whereby color display can be performed at a pixel (1,1) that is formed by the three pixels, i.e., the B, G, and R pixels (1,1) stacked one over another. The scan electrodes constituting the first to m-th rows may be driven in the so-called line sequential mode to rewrite the data voltage at each data electrode of each row (data scan), whereby display data can be output to all of pixels (1,1) to (m, n) to achieve color display of one frame (display screen).

The intermediate state that is a mixture of the planar state and the focal conic state can be obtained to enable full color display be applying a voltage within the two range A or B depicted in FIG. 7 to apply an electric field having an intermediate intensity to the cholesteric liquid crystal and removing the electric field abruptly.

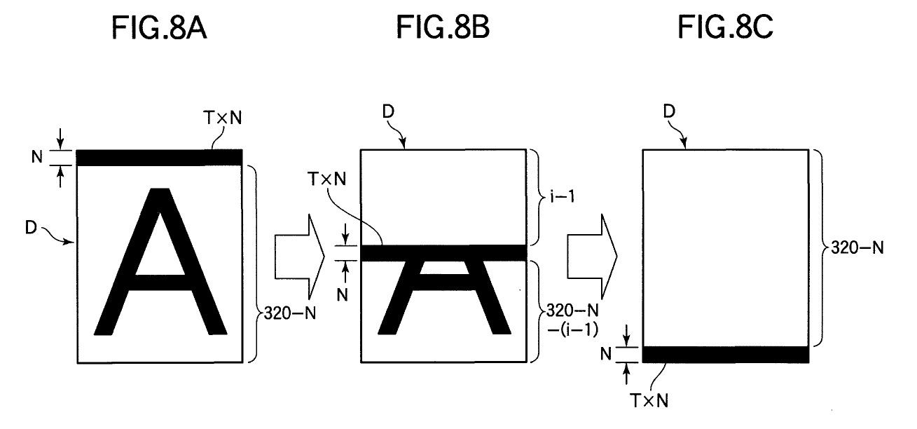

A description will now be made with reference to FIGS. 8A to 10 on a method for a display reset process performed in the liquid crystal display element 1 of the present embodiment. FIGS. 8A to 8C are illustrations depicting the concept of a display reset process according to the present embodiment. FIGS. 8A to 8C depict states of a display surface D of the liquid crystal display element 1 during observed a reset process, and the figures indicate that the reset process proceeds in the order of illustration. FIGS. 8A to 8C depict a portrait display surface D having pixels in 320 rows and 240 columns. As depicted in FIG. 8A, an image of a bold character “A” is depicted on the display surface D before the screen is reset, the image being depicted in the middle of display and sized to extend substantially throughout the screen. The liquid crystals are in the planar state in parts in an area 320-N of display surface D which appear in white in FIG. 8A, and the liquid crystals are in the focal conic state in the part of the character “A” which appears in black.

First, a response time τ(PL→HT) required for the cholesteric liquid crystals to change from the planar state to the homeotropic state is identified in advance. Based on the response time τ(PL→HT), a selection time T required per scan electrode and a simultaneously selected electrode count N, i.e., the number of scan electrodes to be simultaneously selected, are determined in advance such that the product T×N satisfies T×N>τ(PL→HT).

Let us assume that the scan electrodes 17b, 17g, and 17r on the row in an i-th place (i represents an integer equal to or greater than 1) counted from the first row (which is at the top edge of the display surface D depicted in FIG. 8) are collectively referred to as “scan electrodes 17bgr(i)”. Then, the scan electrodes 17bgr(i) are selected N times from the i-th row counted from the first row. Thus, each time a scan signal voltage is applied, a series of N scan electrodes 17bgr(i) to 17bgr(i+N−1) which are simultaneously selected sequentially moves down one row.

The series of N scan electrodes 17bgr(i) to 17bgr(i+N−1) is represented by a region (T×N) which looks like a black horizontal band in FIG. 8, and the liquid crystals are surely in the homeotropic state near the top edge of the band.

FIG. 8B depicts a state in which the series of N scan electrodes 17bgr(i) to 17bgr(i+N−1) has moved from the first row to the middle of the display surface D. FIG. 8C depicts a state in which the series of N scan electrodes 17bgr(i) to 17bgr(i+N−1) has moved to the bottom of the display surface D. As depicted in FIGS. 8B and 8C, the bold character “A” has partially and entirely disappeared in areas (i−1) and (320−N), respectively, through which the region (T×N) looking like a black horizontal band has passed. The percentage of the planar state of the liquid crystals in those areas gradually increases in the bottom-to-top direction of the display surface D.

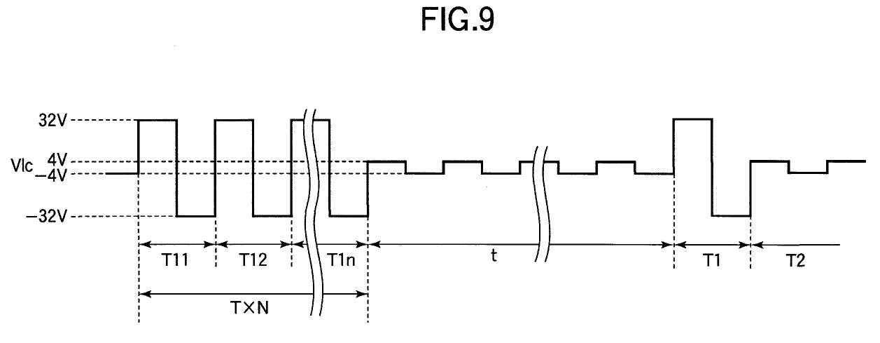

FIG. 9 depicts an example of a display reset driving waveform of the liquid crystal display element 1. A display reset driving method for the liquid crystal display element 1 will be described with reference to FIG. 9. FIG. 9 depicts an applied voltage waveform Vlc which is applied to the liquid crystals on the scan electrodes 17bgr(i) which are subject to a display reset. Referring to FIG. 9, time is depicted to pass in the left-to-right direction, and voltages are plotted in the vertical direction of the figure.

The waveform depicted on the left side of FIG. 9 indicates that the scan electrodes 17bgr(i) in the i-th place counted from the first row are selected N times during selection times T11 to T1n while the series of N scan electrodes 17bgr(i) to (i+N−1) moves on the display surface D downward. A pulse voltage of ±32 V is applied to the liquid crystals on the scan electrodes 17bgr(i) during the N selection times T11 to T1n (all of the selection times T11 to T1n have the same duration in this example). When a high voltage VP100 (e.g., 32 V) is applied to the cholesteric liquid crystals as depicted in FIG. 7 to generate a strong electric field therein, the helical structures of liquid crystal molecules are completely decomposed, and the liquid crystals tend to the homeotropic state in which all liquid crystal molecules follow the direction of the electric field. When such an operation is repeated N times, the liquid crystal molecules of the liquid crystals can be reliably made to enter the homeotropic state within a period that is given by T×N.

As thus described, a scan signal voltage is applied for the selection time T to N scan electrodes which have been simultaneously selected from among the entire scan electrodes (step S1), and a reset voltage for resetting the liquid crystals is applied to the data electrodes 19 in synchronism with the application of the scan signal voltage (step S2) as depicted in FIGS. 8A to 8C. The steps S1 and S2 are repeated with the simultaneously selected N scan electrodes sequentially shifted one place each time the steps are performed, whereby the reset voltage is consecutively applied N times to each pixel on each scan electrode. Since T×N>τ(PL→HT) is true, the cholesteric liquid crystals can be reliably made to enter the homeotropic state in the region like a black horizontal band depicted in FIGS. 8A to 8C. Further, the number of scan electrodes simultaneously selected can be reduced as occasion demands. It is therefore possible to minimize instantaneous electric power required for a reset, and a display reset can be carried out even on a portable apparatus which is limited in instantaneous electric power.

Referring to FIG. 9, data are written in the scan electrodes 17bgr(i) at the i-th place from the first row during a selection time T1 which starts at a time interval t from the reset process having a duration of T×N. During the time t, a pulse voltage VF0 of +4 V is applied to the liquid crystals at the scan electrodes 17bgr(i) in the i-th place from the first row. As a result, the electric field in the liquid crystal is substantially made zero during the time t. When the voltage applied to the liquid crystals changes from the voltage VP100 (±32 V) to the voltage VF0 (±4 V) to make the electric field substantially zero abruptly while the liquid crystal molecules are in the homeotropic state as thus described, the liquid crystal molecules enter a helical state in which their helical axes are oriented in a direction substantially perpendicular to the electrodes 17b and 19b. Thus, the liquid crystals enter the planar state in which light rays in accordance with the helical pitch are selectively reflected, and the transition takes a response time τ(HT→PL).

Data are written in pixels on predetermined scan electrodes after the display reset after the time t (>τ(HT→PL). Thus, the liquid crystal molecules of the liquid crystals are reliably made to enter the planar state within the time t. The driving method depicted in FIGS. 6A, 6B, and 7 may be used as it is to write data during the selection time T1 that comes after the time t passes. Thus, the planar state or the focal conic state can be obtained as desired.

The response time τ(PL→HT) is a time required for a reflectance change from 100% to 10% where reflectance is 100% in the planar state and 0% in the homeotropic state. Similarly, the response time τ(HT→PL) is a time required for a reflectance from 0% to 90% where reflectance is 0% in the homeotropic state and 100% in the planar state and where the applied voltage is removed or made as low as a few volts in the homeotropic state.

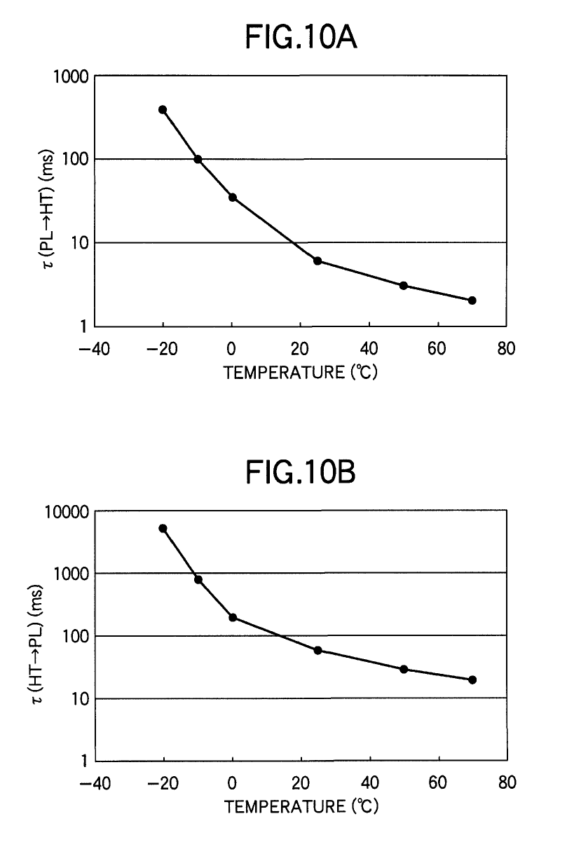

FIGS. 10A and 10B depict temperature dependence of response of a cholesteric liquid crystal to the application of a voltage. In FIG. 10A, temperature dependence of the response time τ(PL→HT) is depicted by plotting response times τ(PL→HT) (ms) along the vertical axis and temperatures (° C.) along the horizontal axis. In FIG. 10B, temperature dependence of the response time τ(HT→PL) is depicted by plotting response times τ(HT→PL) (ms) along the vertical axis and temperatures (° C.) along the horizontal axis. As depicted in FIGS. 10A and 10B, both of the response time τ(PL→HT) and response times τ(HT→PL) (ms) become longer, the lower the temperature.

As a result of a decrease in the temperature, the response time τ(PL→HT) changes in the range from about 2 (ms) to about 600 (ms), whereas the response time τ(HT→PL) changes in the range from about 20 (ms) to about 8000 (ms). Thus, the response time τ(HT→PL) undergoes changes in greater amounts.

In consideration to such temperature dependence of response of a cholesteric liquid crystal, it is preferable to allow the product T×N and the time t to be varied based on the temperature of the liquid crystal at the time of a display reset. By allowing the product T×N and the time t to be optically selected according to the temperature of the liquid crystal, a reset process and display of an image can be stably performed without being affected by fluctuations in ambient temperature. While FIGS. 10A and 10B depict data taken on the liquid crystal for green, the liquid crystals for blue and red exhibit similar tendencies.

As depicted in FIG. 3, the liquid crystal display element 1 of the present embodiment includes a temperature sensor 28 for measuring ambient temperature provided in the neighborhood of the display surface D. Data of ambient temperature measured by the temperature sensor 28 are transmitted to the control section 23. The control section 23 determines a liquid crystal temperature from the ambient temperature and finds the response times τ(PL→HT) and τ(HT→PL) at the liquid crystal temperature. A lookup table (LUT) depicting relationships between temperatures and the response times τ(PL→HT) and τ(HT→PL) created from, for example, in association with FIGS. 10A and 10B is stored in the control section 23. The control section 23 finds response times τ(PL→HT) and τ(HT→PL) from the data of ambient temperature based on the LUT and optimizes the selection period T, the simultaneously selected electrode count N, and the time t based on the response times τ(PL→HT) and τ(HT→PL). Obviously, the control section 23 may apply a function to the curves of temperature dependence depicted in FIGS. 10A and 10B to obtain values of the response times τ(PL→HT) and τ(HT→PL) associated with temperatures.

Specifically, the response times τ(PL→HT) and τ(HT→PL) are 35 ms and 200 ms, respectively, at 0° C. Therefore, at a temperature of 0° C. or higher, the selection time T may be 4 ms, and the simultaneously selected electrode count N may be 10. When the selection time T is 4 ms and the simultaneously selected electrode count N is 10, the time t is 4 ms×(240−10)=920 ms. Therefore, both of the conditions, i.e., the product T×N=40 ms>τ(PL→HT)=35 ms, and time t=920 ms>τ(HT→PL)=200 ms, can be satisfied. Thus, a uniform and high reflectance can be achieved.

Referring to the temperature range between 0° C. and −20° C. (0° C. is excluded), the response times τ(PL→HT) and τ(HT→PL) are 380 ms and 5200 ms, respectively, at −20° C. Let us assume that the selection time T is 20 ms and that the simultaneously selected electrode count N is 20. Then, the product T×N=400 ms>τ(PL→HT)=380 ms, and the product therefore satisfies the condition. However, the time t=20 ms×(240−20)=4400 ms, and the time t therefore becomes shorter than the response time τ(HT→PL) of 5200 ms at −20° C. Thus, time t>τ(HT→PL) is not true, and a sufficient reflectance cannot be achieved.

In the temperature range between 0° C. and −20° C. (0° C. is excluded), it is therefore preferable to set the selection time T at 40 ms and the simultaneously selected electrode count N at 10 than setting the selection time T at 20 ms and the simultaneously selected electrode count N at 20. When the selection time T is 40 ms and the simultaneously selected electrode count N is 10, the product T×N=400 ms>τ(PL→HT)=380 ms. The time t=40 ms×(240−10)=9200 ms>τ(HT→PL)=5200 ms. Therefore, both of the conditions, i.e., the product T×N>τ(PL→HT) and time t>τ(HT→PL), can be satisfied.

As described above, a predetermined pixel can be reset to a reflective state in a stable manner by scanning a plurality of simultaneously selected scan electrodes.

While it is preferable to keep the number of simultaneously selected scan electrodes small from the viewpoint of power consumption, the number of selected electrodes may obviously be increased as occasion demands. It is needless to say that the selection time T, the simultaneously selected electrode count N, and the time t are not limited to the values depicted above.

In the display reset process of the present embodiment improves the display resetting method including the steps of selecting some of scan electrodes simultaneously, applying a reset voltage in synchronism with the selection, and repeating the operation while shifting the simultaneously selected electrodes sequentially one place at each cycle of the operation to put the liquid crystal in the homeotropic state. Specifically, the process allows instantaneous electric power required at the time of a reset to be minimized and allows a reset process to be stably performed in a portable apparatus which is limited in instantaneous electric power.

A method of manufacturing the liquid crystal display element 1 according to this embodiment will now be specifically described.

ITO transparent electrodes are formed using a sputtering process on two PC film substrates 7 and 9 which have been cut to have longitudinal and transversal lengths of, for example, 10 cm and 8 cm. The ITO electrodes are then patterned at a photolithographic step to form electrodes in the form of stripes having a pitch of 0.24 mm (scan electrodes 17 and data electrodes 19) on the respective substrates. Thus, stripe-like electrodes are formed on the two PC film substrates, respectively, to allow QVGA display of 320×240 dots.

Then, a polyimide type alignment film material is applied to the stripe-like transparent electrodes on each of the two PC film substrates to a thickness of about 70 nm using a spin coat process. The two PC film substrates coated with the alignment material are then baked for one hour in an oven at 90° C. to form alignment films.

Then, an epoxy type seal material 21 is applied to a peripheral part of either of the PC film substrates using a dispenser. Next, spherical spacers (manufactured by SEKISUI FINE CHEMICAL) are dispersed on the other PC film substrate i.e., the substrate 9 or 7 to adjust the cell gap (the thickness of the liquid crystal layer) to about 4 μm. Then, the two PC film substrates 7 and 9 are combined and heated for one hour at 160° C. to cure the seal material 21. Then, a B cholesteric liquid crystal LCb is injected using a vacuum injection process, and the injection port is thereafter sealed with an epoxy type sealing material to fabricate a B display portion 6b. G and R display portions 6g and 6r are fabricated using substantially the same method.

Next, the B, G, and R display portions 6b, 6g, and 6r are formed one over another in the order listed from the side of a display surface, as depicted in FIG. 4. Then, a visible light absorbing layer 15 is disposed on a bottom surface of a bottom substrate 9r of the R display portion 6r. General purpose STN driver ICs in a TCP structure are then crimped to terminal parts of the scan electrodes 17 and data electrodes 19 of the B, G, and R display portions 6b, 6g, and 6r formed one over another, and a power supply circuit and a control section 23 are further connected. Thus, a liquid crystal display element 1 capable of QVGA display is completed.

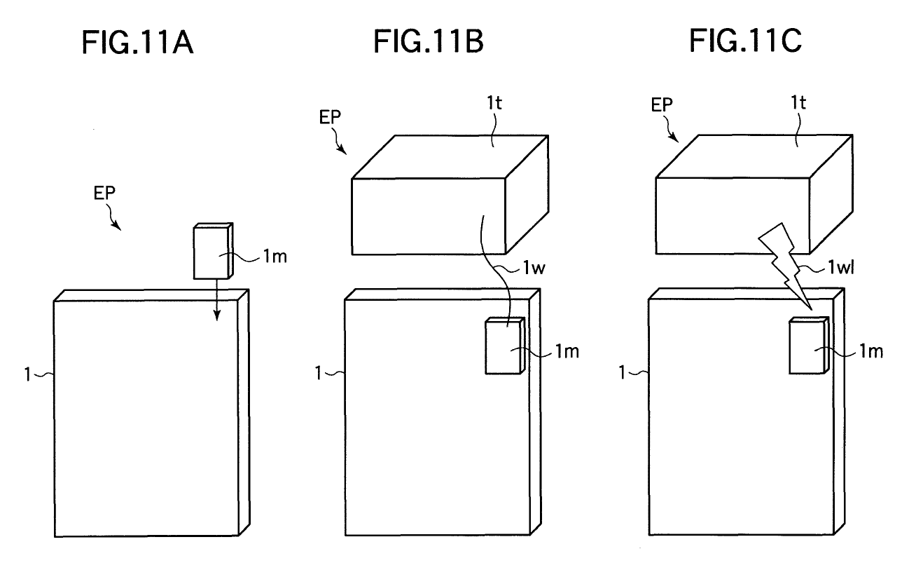

Electronic paper is completed by providing the liquid crystal display element 1 thus completed with an input/output device and a control device for exercising overall control of the element (neither of the devices is depicted). FIGS. 11A to 11C depict specific examples of electronic paper EP having a liquid crystal display element 1 according to the present embodiment. FIG. 11A depicts electronic paper EP which is configured to use a non-volatile memory l1 having image data stored therein in advance by inserting and removing it to and from a liquid crystal display element 1 according to the embodiment. For example, image data in a personal computer or the like is stored in the non-volatile memory l1, and an image may be displayed by inserting the memory into the electronic paper EP.

FIG. 11B depicts electronic paper EP configured by incorporating a non-volatile memory l1 in a liquid crystal display element 1 according to the embodiment. For example, image data stored in a terminal it (the terminal it may form a part of the electronic paper EP) can be transferred by wire and stored in the non-volatile memory l1 to display an image.

FIG. 11C depicts an example in which a wireless transmission/reception system lwl (e.g., a radio LAN or Bluetooth system) is provided for a terminal it and a liquid crystal display element 1. Image data stored in the terminal it can be transferred through the wireless transmission/reception system lwl and stored in a non-volatile memory l1 to display an image.

As described above in detail, problems encountered at the time of a display reset of a display device utilizing cholesteric liquid crystals can be solved in the present embodiment. Electronic paper utilizing such a display device can be also provided.

The invention is not limited to the above-described embodiment and may be modified in various ways.

The above embodiment has been described as a liquid crystal display element having a three-layer structure formed by forming B, G, and R display portions 6b, 6g, and 6r one over another as an example. However, the invention is not limited to such an element and may be applied to liquid crystal display elements having a multi-layer structure with two layers or four or more layers. Obviously, the invention may be applied to liquid crystal display elements having a single-layer structure.

The above embodiment has been described as a liquid crystal display element including display portions 6b, 6g, and 6r having liquid crystals 3b, 3g, and 3r for reflecting blue, green, and red rays of light in the planar state, as an example. However, the invention is not limited to such an element and may be applied to liquid crystal display elements including a stack of plural display portions having respective liquid crystals for reflecting cyan, magenta, and yellow rays of light in the planar state enclosed therein.

What is claimed is:

1. A method of driving a liquid crystal display element comprising:
applying a scan signal voltage to N scan electrodes simultaneously selected from among a plurality of scan electrodes formed in parallel on an inner surface of one of a pair of substrates between which a cholesteric liquid crystal selectively reflecting light having a predetermined wavelength is enclosed for a selection time T and applying a reset voltage for resetting the liquid crystal to a plurality of data electrodes formed on an inner surface of the other of the pair of substrates so as to intersect the plurality of scan electrodes when viewed in the normal direction of a substrate surface, the reset voltage being applied in synchronism with the application of the scan signal voltage, wherein
the applying process is repeated while shifting the N simultaneously selected scan electrodes sequentially to perform a display reset for putting the liquid crystal in a homeotropic state by applying the reset voltage to each pixel on each of the scan electrodes N times consecutively, and
the display reset is performed using such a selection time T and a simultaneously selected electrode count N that the product T×N satisfies T×N>τ1 where τ1 represents a response time required for the liquid crystal to change from a planar state to the homeotropic state.

2. The method according to claim 1, wherein data is written in a pixel on a predetermined scan electrode after the display reset such that t>τ2 is true where t represents the time spent before the data write is started after the display reset and τ2 represents a response time required for the liquid crystal to change from the homeotropic state to the planar state.

3. The method according to claim 2, wherein the product T×N and the time t are determined based on the temperature of the liquid crystal at the time of the display reset.

4. A liquid crystal display element comprising:
a display section including:
a pair of substrates between which a cholesteric liquid crystal selectively reflecting light having a predetermined wavelength is enclosed;
a plurality of scan electrodes which are formed in parallel on an inner surface of one of the pair of substrates and which are sequentially selected to be applied with a scan signal voltage in the form of a pulse;
a plurality of data electrodes which are formed on an inner surface of the other of the pair of substrates so as to intersect the plurality of scan electrodes when viewed in the normal direction of a substrate surface and to which a data voltage in the form of a pulse is applied in synchronism with the application of the scan signal voltage; and
a plurality of pixels disposed at intersections between the plurality of scan electrodes and the plurality of data electrodes; and
a control section which repeats the step of applying a scan signal voltage to N scan electrodes simultaneously selected from among the scan electrodes for a selection period T and applying a reset voltage for resetting the liquid crystal to the plurality of data electrodes in synchronism with the application of the scan signal voltage while shifting the N simultaneously selected scan electrodes sequentially (one place each time the step is performed) to perform a display reset for putting the liquid crystal in a homeotropic state by applying the reset voltage to each pixel on each of the scan electrodes N times consecutively, the control section determining the selection time T and the simultaneously selected electrode count N such that the product T×N satisfies T×N>τ1 where τ1 represents a response time required for the liquid crystal to change from a planar state to the homeotropic state.

5. The liquid crystal display element according to claim 4, wherein data is written in a pixel on a predetermined scan electrode after the display reset such that t>τ2 is true where t represents the time spent before the data write is started after the display reset and where τ2 represents a response time required for the liquid crystal to change from the homeotropic state to the planar state.

6. The liquid crystal display element according to claim 5, wherein the control section determines the product T×N and the time t based on the temperature of the liquid crystal at the time of the display reset.

7. The liquid crystal display element according to claim 4, comprising:
a blue display portion having a liquid crystal for blue selectively reflecting blue light enclosed between substrates provided opposite to each other;
a green display portion having a liquid crystal for green selectively reflecting green light enclosed between substrates provided opposite to each other; and
a red display portion having a liquid crystal for red selectively reflecting red light enclosed between substrates provided opposite to each other,
wherein the display portions are formed one over another.

8. The liquid crystal display element according to claim 7, wherein the blue display portion, the green display portion, and the red display portion are formed one over another in the order listed from the side of the element where a display surface is provided.

9. The liquid crystal display element according to claim 8, wherein optical rotatory power of the liquid crystal for green is different from optical rotator power of the liquid crystal for blue and the liquid crystal for red.

10. Electronic paper comprising a liquid crystal display element according to claim 4.
